(19) United States
(12) Patent Application Publication
(10) Pub. No.: US 2010/0126888 A1
(43) Pub. Date: May 27, 2010

(54) ALGINATE IMPRESSION METHOD FOR DENTAL TREATMENT

(76) Inventor: JONGWOOK LEE, Rancho Palos Verdes, CA (US)

Correspondence Address: PARK LAW FIRM, 3255 WILSHIRE BLVD, SUITE 1110, LOS ANGELES, CA, 90010, US

(21) Appl. No.: 12/324,384

(22) Filed: Nov. 26, 2008

(51) Int. Cl. A61C 13/20; B65D 25/08

(52) U.S. Cl. 206/219; 433/215

(57) ABSTRACT

An alginate impression method for dental treatment is provided. The method comprises steps of: separating a first portion and a second portion in a squeezable pouch with a separator; providing alginate in the first portion; providing water in the second portion; breaking the separator by squeezing the squeezable pouch; kneading the squeezable pouch so as to mix the alginate and the water inside; and squeezing out the mixed alginate and water onto a mold so as to make an impression. The squeezable pouch comprises a container portion, an opening, and a lid. The lid is configured to fit air-tightly with the opening of the squeezable pouch. The opening of the squeezable pouch comprises male threads inside the opening, and the lid of the pouch comprises female threads fitting with the male threads in the opening.

### BACKGROUND OF THE INVENTION

The present invention relates to an alginate impression method. More particularly, this invention relates to an alginate impression method, which enables to conserve time, labor, material, and maintenance.

Preparing a mold is usually messy job in the community. A rubber bowl and a mixing spatula are needed to mix the alginate, the molding material in a dental clinic, with water as shown in FIG. 1.

One cannot avoid wasting material and cleaning the bowl and spatula after molding in the traditional method to mix alginate with water using the bowl and the spatula. Usually, it takes a lot of water clean the bowl and the spatula after the work.

With the traditional method to mix the alginate with water in the bowl using spatula, it takes more time and effort.

Accordingly, a need for an alginate impression method has been present for a long time in the community considering its extensive usage. This invention is directed to solve these problems and satisfy the long-felt need.

### SUMMARY OF THE INVENTION

The present invention contrives to solve the disadvantages of the prior art.

An objective of the invention is to provide an alginate impression method for dental treatment.

Another object of the invention is to provide an alginate impression method, which enables clean mixing process.

Still another object of the invention is to provide an alginate impression method, which enables conserving molding material.

An aspect of the invention provides an alginate impression method for dental treatment.

The method comprises steps of: separating a first portion and a second portion in a squeezable pouch with a separator; providing alginate of a first predetermined amount in the first portion of the squeezable pouch; providing water of a second predetermined amount in the second portion of the squeezable pouch; breaking the separator by squeezing the squeezable pouch; kneading the squeezable pouch so as to mix the alginate and the water inside; and squeezing out the mixed alginate and water from the opening of the pouch onto a mold so as to make an impression.

The method may further comprise, prior to the step of providing alginate, a step of measuring the first predetermined amount of alginate.

The method may further comprise, prior to the step of providing water, a step of measuring the second predetermined amount of water.

The squeezable pouch may further comprise a container portion, an opening, and a lid. The lid may be configured to fit air-tightly with the opening of the squeezable pouch.

The opening of the squeezable pouch may comprise a plurality of male threads inside the opening, and the lid of the pouch may comprise a plurality of female threads fitting with the male threads in the opening of the squeezable pouch.

Alternatively, the opening of the squeezable pouch may comprise a plurality of female threads around the opening, and the lid of the pouch may comprise a plurality of male threads fitting with the female threads in the opening of the squeezable pouch.

The method may further comprise, prior to the step of squeezing out, a step of opening the lid out of the squeezable pouch.

The step of kneading may comprise a step of shaking the squeezable pouch.

The method may further comprise a step of discarding the squeezable pouch after the step of squeezing out.

Another aspect of the invention provides an alginate pouch package for dental impression.

The package comprise: a squeezable pouch; a first predetermined amount of alginate powder; and a second predetermined amount of water.

The squeezable pouch comprises a container portion, a first portion provided in the container portion, a second portion provided in the container portion, a separator provided between the first and second portions for separating the first portion from the second portion, and a lid.

The first predetermined amount of alginate powder is disposed in the first portion of the squeezable pouch.

The second predetermined amount of water is disposed in the second portion of the squeezable pouch.

The lid seals the squeezable pouch air-tightly.

The separator may be configured to rupture under a predetermined straining force.

The straining force may be provided by kneading a portion of the squeezable pouch.

The opening of the squeezable pouch may comprise a plurality of male threads around the opening.

The lid may comprise a plurality of female threads fitting with the plurality of male threads of the opening of the squeezable pouch.

The first predetermined amount of alginate and the second predetermined amount of water may be configured to obtain an alginate-water mixture having a desired viscosity.

A portion of the squeezable pouch may be transparent so as to peek into what happens inside.

The advantages of the present invention are: (1) the alginate impression method makes alginate impression easier and cleaner; and (2) the material for the alginate impression can save a lot using the alginate impression method.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing mixing alginate with water in a bowl with a spatula according to a prior art;

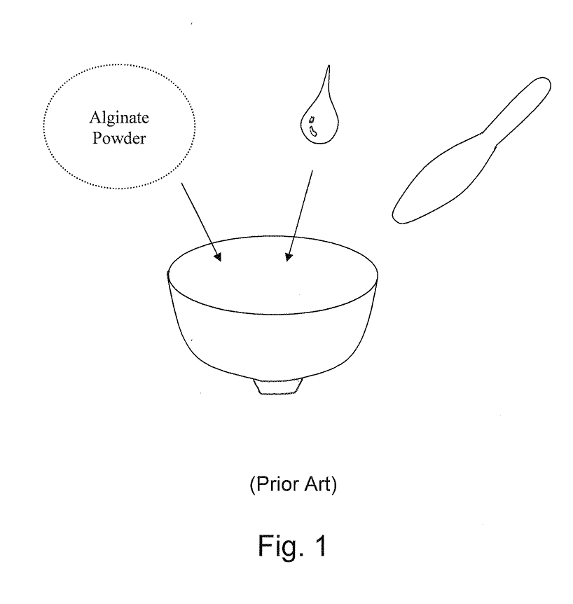

FIG. 2 is a flowchart showing an alginate impression method according to an embodiment of the invention;

FIG. 3 is a cross-sectional view of a squeezable pouch having alginate and water for an alginate impression method according to an embodiment of the invention;

FIG. 4 is a perspective view of a squeezable pouch according to another embodiment of the invention; and

FIG. 5 is a perspective view of a squeezable pouch through a transparent window showing breaking a separator according to another embodiment of the invention.

### DETAILED DESCRIPTION EMBODIMENTS OF THE INVENTION

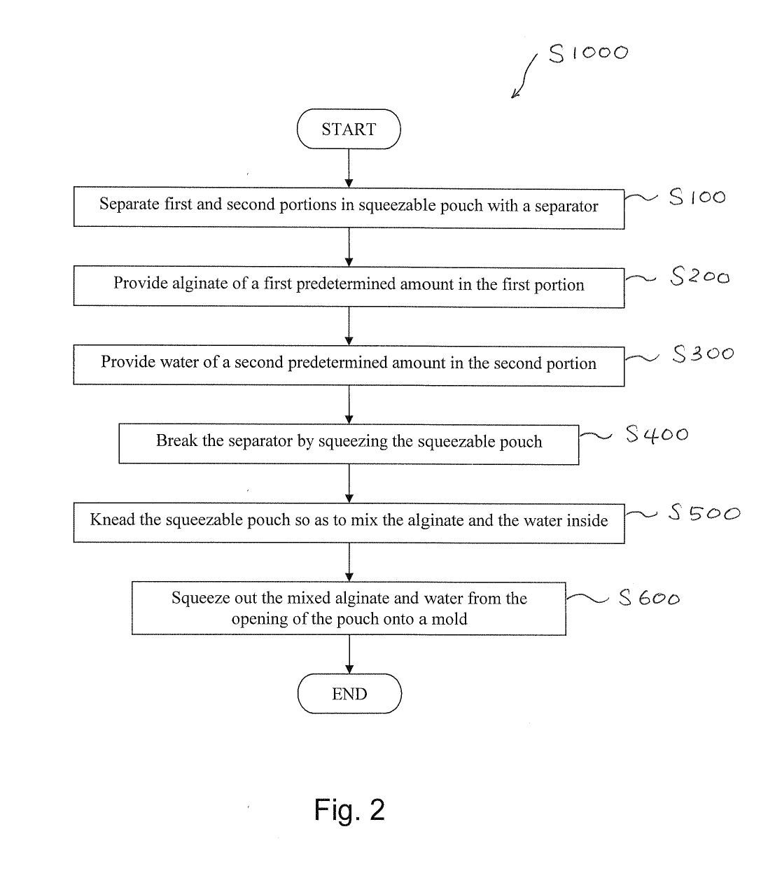

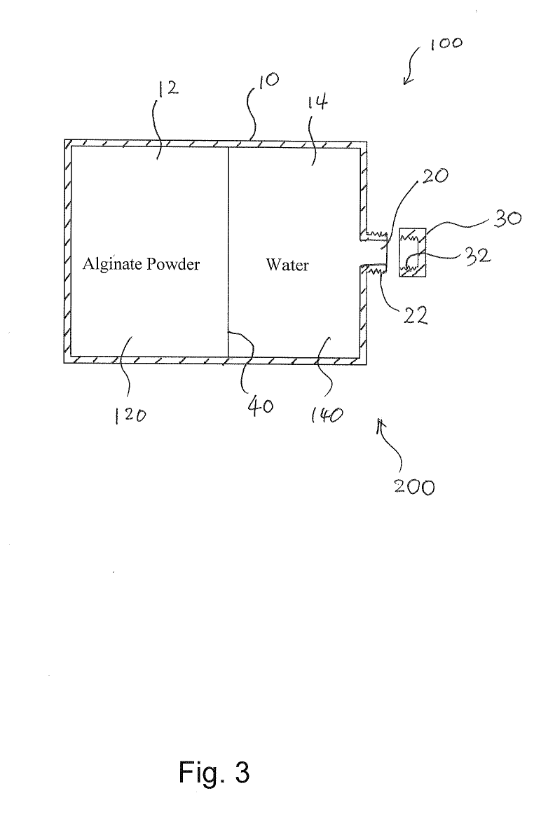

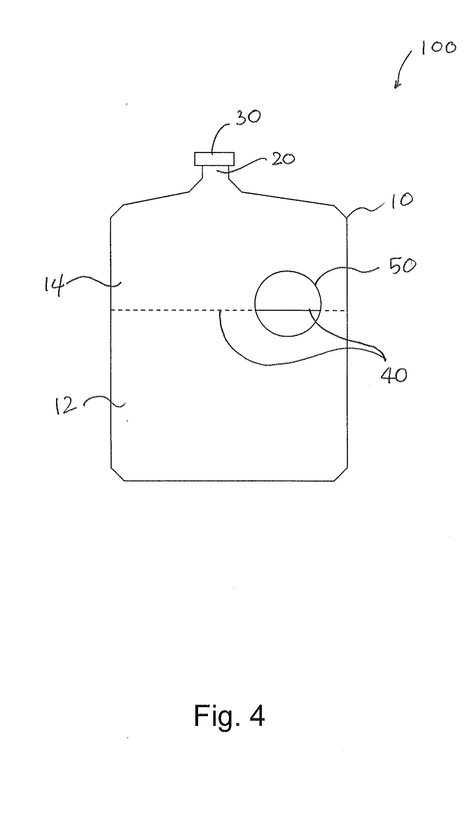

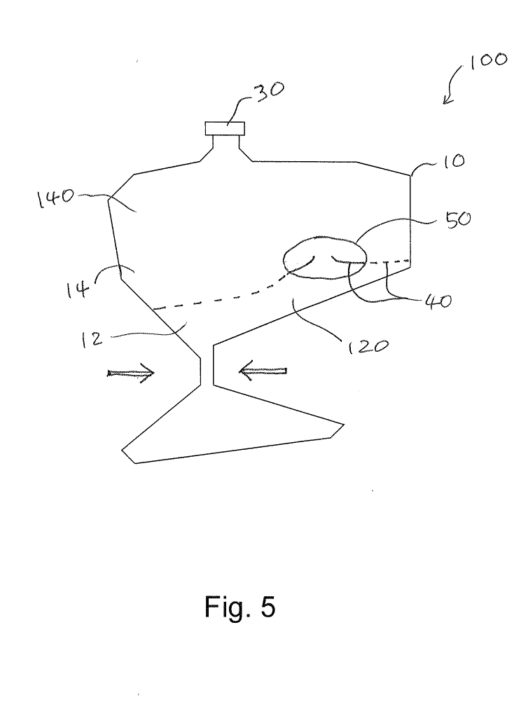

FIG. 2 is a flowchart showing an alginate impression method S1000 according to an embodiment of the invention; FIG. 3 is a cross-sectional view of a squeezable pouch 100 having alginate and water for the alginate impression method S1000 according to an embodiment of the invention; FIG. 4 is a perspective view of a squeezable pouch 100 according to another embodiment of the invention; and FIG. 5 is a perspective view of a squeezable pouch 100 through a transparent window showing breaking a separator according to another embodiment of the invention.

An aspect of the invention provides the alginate impression method S1000 for dental treatment as shown in FIG. 2.

The method S1000 comprises steps of: separating a first portion 12 and a second portion 14 in a squeezable pouch 100 with a separator 40 (S100); providing alginate of a first predetermined amount in the first portion 12 of the squeezable pouch 100 (S200); providing water of a second predetermined amount in the second portion 14 of the squeezable pouch 100′ (S300); breaking the separator 40 by squeezing the squeezable pouch 100 (S400); kneading the squeezable pouch 100 so as to mix the alginate and the water inside (S500); and squeezing out the mixed alginate and water from the opening 20 of the pouch 100 onto a mold so as to make an impression (S600).

The method S1000 may further comprise, prior to the step S200 of providing alginate, a step of measuring the first predetermined amount of alginate.

The method may further comprise, prior to the step S300 of providing water, a step of measuring the second predetermined amount of water.

The squeezable pouch 100 may further comprise a container portion 10, an opening 20, and a lid 30. The lid 30 may be configured to fit air-tightly with the opening 20 of the squeezable pouch 100.

The opening 20 of the squeezable pouch 100 may comprise a plurality of male threads 22 inside the opening 20, and the lid 30 of the pouch 100 may comprise a plurality of female threads 32 fitting with the male threads 22 in the opening 20 of the squeezable pouch 100.

Alternatively, the opening 20 of the squeezable pouch 100 may comprise a plurality of female threads around the opening 20, and the lid 30 of the pouch 100 may comprise a plurality of male threads fitting with the female threads in the opening 20 of the squeezable pouch 100.

The method S1000 may further comprise, prior to the step S600 of squeezing out, a step of opening the lid out of the squeezable pouch.

The step S500 of kneading may comprise a step of shaking the squeezable pouch.

The method S000 may further comprise a step of discarding the squeezable pouch 100 after the step S600 of squeezing out.

Another aspect of the invention provides an alginate pouch package 200 for dental impression as shown in FIG. 3.

The package 200 comprise: a squeezable pouch 100; a first predetermined amount of alginate powder 120; and a second predetermined amount of water 140.

The squeezable pouch 100 comprises a container portion 10, a first portion 12 provided in the container portion 10, a second portion 14 provided in the container portion 10, a separator 40 provided between the first and second portions 12, 14 for separating the first portion 12 from the second portion 14, and a lid 30.

The first predetermined amount of alginate powder 120 is disposed in the first portion 12 of the squeezable pouch 100.

The second predetermined amount of water 140 is disposed in the second portion 14 of the squeezable pouch 100.

The lid 30 seals the squeezable pouch 100 air-tightly.

The separator 40 may be configured to rupture under a predetermined straining force denoted by two arrows in FIG. 5.

The straining force may be provided by kneading a portion of the squeezable pouch 100 as shown in FIG. 5.

The opening 20 of the squeezable pouch 100 may comprise a plurality of male threads 22 around the opening 20.

The lid 30 may comprise a plurality of female threads 32 fitting with the plurality of male threads 22 of the opening 20 of the squeezable pouch 100.

The first predetermined amount of alginate 120 and the second predetermined amount of water 140 may be configured to obtain an alginate-water mixture having a desired viscosity.

A portion 50 of the squeezable pouch 100 may be transparent so as to peek into what happens inside as shown in FIGS. 4 and 5. The transparent portion 50 is a sort of window to peek into the pouch to check whether mixing is done or not.

In certain embodiments of the invention, the squeezable pouch 100 may be substantially parallelepiped and rather flat along a direction, in which the separator 40 may be broken more easily.

In certain embodiments of the invention, the alginate 120 and the water 140 may change their position in FIG. 3. That is, the alginate 120 may be disposed in the second portion 14 of the pouch 100, and the water 140 in the first portion 12 of the pouch 100.

Still in certain embodiments of the invention, a portion of the separator 40 may be weaker than the remaining portions, such that squeezing breaks the weak portion rather than the other stronger portion.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An alginate impression method for dental treatment, the method comprising steps of:
separating a first portion and a second portion in a squeezable pouch with a separator;
providing alginate of a first predetermined amount in the first portion of the squeezable pouch;
providing water of a second predetermined amount in the second portion of the squeezable pouch;
breaking the separator by squeezing the squeezable pouch;
kneading the squeezable pouch so as to mix the alginate and the water inside; and
squeezing out the mixed alginate and water from the opening of the pouch onto a mold so as to make an impression.

2. The method of claim 1, further comprising, prior to the step of providing alginate, a step of measuring the first predetermined amount of alginate.

3. The method of claim 1, further comprising, prior to the step of providing water, a step of measuring the second predetermined amount of water.

4. The method of claim 1, wherein the squeezable pouch further comprises a container portion, an opening, and a lid.

5. The method claim 4, wherein the lid is configured to fit air-tightly with the opening of the squeezable pouch.

6. The method of claim 5, wherein the opening of the squeezable pouch comprises a plurality of male threads inside the opening, and wherein the lid of the pouch comprises a plurality of female threads fitting with the male threads in the opening of the squeezable pouch.

7. The method of claim 5, wherein the opening of the squeezable pouch comprises a plurality of female threads around the opening, and wherein the lid of the pouch comprises a plurality of male threads fitting with the female threads in the opening of the squeezable pouch.

8. The method of claim 1, further comprising, prior to the step of squeezing out, a step of opening the lid out of the squeezable pouch.

9. The method of claim 1, wherein the step of kneading comprises a step of shaking the squeezable pouch.

10. The method of claim 1, further comprising a step of discarding the squeezable pouch after the step of squeezing out.

11. An alginate pouch package for dental impression, comprising:
a squeezable pouch comprising a container portion, a first portion provided in the container portion, a second portion provided in the container portion, a separator provided between the first and second portions for separating the first portion from the second portion, and a lid;
a first predetermined amount of alginate powder disposed in the first portion of the squeezable pouch; and
a second predetermined amount of water disposed in the second portion of the squeezable pouch,
wherein the lid seals the squeezable pouch air-tightly.

12. The package of claim 11, wherein the separator is configured to rupture under a predetermined straining force.

13. The package of claim 12, wherein the straining force is provided by kneading a portion of the squeezable pouch.

14. The package of claim 11, wherein the opening of the squeezable pouch comprises a plurality of male threads around the opening.

15. The package of claim 14, wherein the lid comprises a plurality of female threads fitting with the plurality of male threads of the opening of the squeezable pouch.

16. The package of claim 11, wherein the first predetermined amount of alginate and the second predetermined amount of water are configured to obtain an alginate-water mixture having a desired viscosity.

17. The package of claim 11, wherein a portion of the squeezable pouch is transparent so as to peek into what happens inside.
